(19) United States
(12) Patent Application Publication
(10) Pub. No.: US 2009/0106105 A1
(43) Pub. Date: Apr. 23, 2009

(54) METHODS AND SYSTEMS FOR PROVIDING TARGETED ADVERTISEMENTS OVER A NETWORK

(75) Inventors: Steve Lewis, Cambridge, MA (US); Gerard Memmi, Cambridge, MA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: HIRE REACH, INC., Cambridge, MA (US)

(21) Appl. No.: 12/194,862

(22) Filed: Aug. 20, 2008

Related U.S. Application Data
(60) Provisional application No. 60/981,592, filed on Oct. 22, 2007.
(60) Provisional application No. 61/081,762, filed on Jul. 18, 2008.

(51) Int. Cl. G06Q 30/00; G06Q 90/00

(52) U.S. Cl. 705/14; 705/1

(57) ABSTRACT

Methods and systems are provided for providing targeted advertisements over a network, and in particular to methods and systems for selecting and delivering employment advertisements to prospective employees over a network. In general, the methods and systems can allow an employer to identify and recruit qualified talent they cannot easily or efficiently reach using traditional employment advertising and online job posting systems.

### CROSS-REFERENCE TO RELATED APPLICATIONS

This application claims priority to U.S. Provisional Patent No. 60/981,592 filed Oct. 22, 2007 and entitled “Targeted Employment Advertisement System,” and to U.S. Provisional Patent No. 61/081,762 filed Jul. 18, 2008 and entitled “Methods and Systems For Providing Targeted Advertisements Over A Network,” which are hereby incorporated by reference in their entireties.

### FIELD OF THE INVENTION

The present invention relates to methods and systems for providing targeted advertisements over a network, and in particular to methods and systems for selecting and delivering employment advertisements to prospective employees over a network.

### BACKGROUND OF THE INVENTION

Corporations spend large amounts of resources such as time and money on candidate sourcing. Some employment positions, such as those in scientific or technical fields requiring candidates with specialized skills and advanced university degrees, can be particularly difficult for corporations to fill. Corporations can take various human resource efforts for candidate sourcing, with such efforts often including posting employment advertisements to a potentially wide audience in print publications, on the corporation's Internet website, and/or on other Internet websites. Placing such advertisements consumes valuable corporate resources but does not always reach qualified potential employees, and responses to such advertisements can result in numerous unsuitable job candidates that require further corporate resources to process for suitability before, during, and/or following an interview.

Furthermore, qualified employment candidates do not always actively seek job openings. Sometimes a job seeker may take a passive job search approach and rely on word-of-mouth regarding employment opportunities, particularly if the job seeker is not looking for immediate new employment. Sometimes a person may not be actively considering a change in employment but nevertheless would be interested in learning about available opportunities related to their educational and professional experience. Sometimes a person does not want to make their resume or other professional details available online for perusal by prospective employers, such as through recruitment websites or bulletin boards, because discovery of the resume by a current employer could adversely affect the person's current work environment. In any event, a pool of qualified candidates for a job position can exist, but a corporation, independently and/or through a third party service such as a head hunter or search firm, can have difficulty reaching that pool with details of employment opportunities if potential candidates within that pool are not actively searching for job openings.

Moreover, the more difficult it is to locate candidates for a particular job, the longer a corporation can have an employment vacancy while appropriate candidates are sought, thereby reducing the corporation's ability to properly staff its projects and achieve its corporate goals. Continuing to place advertisements for unfilled job positions can also cost a significant amount of resources. Sometimes the cost of advertising can prohibit continued running of advertisements, particularly for smaller corporations, which can further limit a corporation's ability to staff a position to lower cost, and typically lower visibility, options.

Accordingly, there is a need for methods and systems for providing targeted advertisements to prospective employees, particularly over a network such as the Internet.

### SUMMARY OF THE INVENTION

The present invention generally provides methods and systems for providing targeted advertisements over a network, and in particular to methods and systems for selecting and delivering employment advertisements to prospective employees over a network. In one aspect, a method of providing targeted advertisements is provided that includes associating in an electronic database at least one employment skill with each of a plurality of employment positions, associating in an electronic database at least one employment skill with each of a plurality of media materials a user can acquire through a transaction at least partially transacted over a network, and selecting an employment advertisement to provide over a network to a user who selects acquisition of a media material in a transaction occurring at least partially over the network. The selected employment advertisement is for an employment position associated with at least one employment skill also associated with the user-selected media material.

The method can have any number of variations. For example, the method can include providing the selected employment advertisement to the user over the network at a time substantially when the user selects acquisition of the media material and/or at a time substantially when the user confirms payment for acquisition of the media material. As another example, the method can include associating in an electronic database a skill level with each of the plurality of employment positions and associating in an electronic database a skill level with each of the plurality of media materials a user can acquire through a transaction at least partially transacted over a network, with the selected employment advertisement being for an employment position having an associated skill level that matches a skill level associated with the user-selected media material. In still another example, the method can include associating in an electronic database a desirability with each employment skill associated with each of the plurality of employment positions, with the selected employment advertisement being for an employment position associated with the employment skill having a highest desirability of a plurality of employment skills that match between the employment position and the user-selected media material. As another example, the method can include associating in an electronic database a confidence level with an employment skill associated with a media material, the confidence level indicating a probability that a user selecting acquisition of the media material has the employment skill associated with the media material. As yet another example, the method can include identifying a keyword associated with a media material and associating in an electronic database at least one employment skill with the media material based on the keyword. In some embodiments, the keyword is identified based on at least one of a title of the media material, an abstract of the media material, a table of contents of the media material, and an author of the media material. As another example, the method can include generating a score for each of a plurality of employment advertisements, with the selected employment advertisement having a score above a threshold value. The method can further include selecting a plurality of employment advertisements to provide over the network to the user, each of the plurality of selected advertisements having a score above the threshold value. As still another example, the method can include correlating, before the user selects acquisition of the media material, at least one of the plurality of employment positions with at least one of the plurality of media materials if the at least one of the plurality of employment positions is associated with at least one employment skill also associated with the at least one of the plurality of media materials. As yet another example, at least one employment skill associated with the selected employment advertisement can be an exact match or a related match with at least one employment skill associated with the user-selected media material.

In some embodiments, if the user selects acquisition of a plurality of media materials in a transaction occurring at least partially over the network, the selected employment advertisement has at least one commonly associated employment skill with each of the plurality of media materials. The at least one commonly associated employment skill can be the same or different for each of the plurality of media materials.

In another aspect, a system for providing targeted advertisements is provided that includes first, second, and third collections of data, a matching engine processor, and an employment advertisement processor. The first collection of data includes a plurality of job nodes, each job node associated with an employment position. The second collection of data includes a plurality of skill nodes, each skill node associated with an employment skill and associated with at least one of the job nodes. The third collection of data includes a plurality of media nodes, each media node associated with a media material that a user can acquire through a transaction conducted at least partially over a network, and each media node associated with an employment skill associated with at least one of the skill nodes. The matching engine processor can select at least one of the job nodes based at least on a selection by a user over a network of a media material to be delivered to the user, with the media material selected by the user being associated with one of the media nodes. The employment advertisement processor can cause an employment advertisement to be delivered to the user over the network for an employment position associated with the job node selected by the matching engine processor.

The first, second, and third collections of data can be configured in a variety of ways. For example, at least one of the first collection of data, the second collection of data, and the third collection of data can be configured as a directed acyclic graph (DAG). In some embodiments, the second collection of data is configured as a DAG, and a selected skill node in the plurality of skill nodes is further associated with an employment skill associated with a skill node in the plurality of skills nodes located downstream in the second collection of data from the selected skill node.

The matching engine processor can select one of the job nodes in a variety of ways. For example, the matching engine processor can be configured to select one of the job nodes considering a desirability of an employment skill associated with the media node for the user-selected media material. In some embodiments, if the user selects a plurality of media materials to be delivered to the user, the matching engine processor can be configured to select a job node considering each of the user-selected media materials, with each of the media materials selected by the user being associated with one of the media nodes.

In another aspect, a system is provided for serving employment advertisements to a user who is browsing for professional content through a content provider's server. The system includes an ontology processor, a matching engine processor, and an employment advertisement processor. The ontology processor has a memory for storing employment, skill, and content information in a graph having nodes associated with content, nodes associated with skills, and nodes associated with employment positions. The graph's nodes are connected by edges that represent associations between the content, skills, and employment positions. The matching engine processor is in communication with a content provider's server to monitor the behavior of users interacting with content through the content provider's server. The matching engine processor further communicates with the ontology processor to generate a score that a user is qualified for an employment position based upon the user's behavior with respect to the content and the associations between the content, skills, and employment positions stored by the ontology processor. The employment advertisement processor can cause an employment advertisement to be displayed to the user for an employment position for which the matching engine processor has calculated a qualifying score.

The media material can include a variety of materials. For example, the media material can include at least one of a book, an article, an audio file, and a video file.

In some embodiments, the employment advertisement is associated with a geographic region of the user and/or with a purchase history of the user.

### BRIEF DESCRIPTION OF THE DRAWINGS

The invention will be more fully understood from the following detailed description taken in conjunction with the accompanying drawings, in which:

FIG. 1 is a schematic diagram of an embodiment of a targeted advertising system;

FIG. 2 is a schematic diagram of an embodiment of an advertising processing system;

FIG. 3 is an embodiment of a job type directed acyclic graph that can be stored in the advertising processing system of FIG. 2;

FIG. 3A is a pre-propagation embodiment of the job type directed acyclic graph of FIG. 3;

FIG. 4 is an excerpt of an embodiment of a job type table that can be stored in the advertising processing system of FIG. 2;

FIG. 5 is an embodiment of a media material type directed acyclic graph that can be stored in the advertising processing system of FIG. 2;

FIG. 5A is a pre-propagation embodiment of the media material type directed acyclic graph of FIG. 5;

FIG. 6 is an excerpt of an embodiment of a media material type table that can be stored in the advertising processing system of FIG. 2;

FIG. 7 is an excerpt of an embodiment of a skills type table that can be stored in the advertising processing system of FIG. 2;

FIG. 8 is a graph showing a model of a user's possible skill level over time;

FIG. 9 is an embodiment of a decision graph that can be stored in the advertising processing system of FIG. 2;

FIG. 10 is a schematic diagram of another embodiment of a targeted advertising system;

FIG. 11 is a flowchart showing an embodiment of a targeted advertisement selection process; and

FIG. 12 is a flowchart showing an embodiment of an employment advertisement selection process that can be included in the targeted advertisement selection process of FIG. 11.

### DETAILED DESCRIPTION OF THE INVENTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The present invention generally provides methods and systems for providing targeted advertisements over a network, and in particular to methods and systems for selecting and delivering employment advertisements to prospective employees over a network. In general, the methods and systems can allow an employer to identify and recruit qualified talent they cannot easily or efficiently reach using traditional employment advertising and online job posting systems.

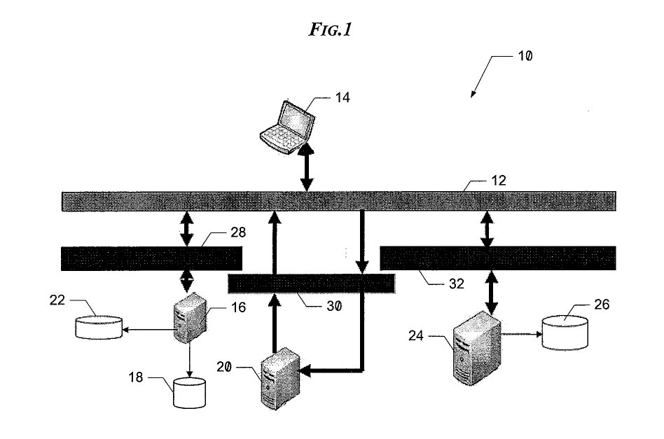

FIG. 1 illustrates an embodiment of a system 10 that can allow targeted advertisements to be provided to a user over a network 12. The user, e.g., a buyer or a prospective employee, can include a person interacting with the network 12 via a client terminal 14. Through the client terminal 14, the user can electronically communicate via a website, a bulletin board, or other network interface with a seller's processing server 16. Generally, in a transaction occurring at least partially over the network 12, the user can communicate with the seller's server 16 via the client terminal 14 to select acquisition of a media material (e.g., a book, an article, a research or white paper, a review, a blog entry, a web page, a graduate thesis, an audio file, a video file, software, a product specification or other product information page, etc.) catalogued and/or stored in a media materials database 18. By way of non-limiting example only, the user can order for postal mail shipping one or more books through a website associated with the seller's server 16. More generally, acquiring a media material can include any manner of accessing that material through a transaction that can be tracked by the system disclosed herein.

The user's media material selection can be electronically communicated across the network 12 from the seller's server 16 to an advertiser's processing server 20. Based on the user's media material selection, the advertiser's processing server 20 can determine an employment advertisement stored in an advertisement database 22 to provide to the user over the network 12 such that the user can view the selected employment advertisement through the client terminal 14. If the user via the client terminal 14 clicks on the employment advertisement using a web browser or otherwise chooses to access more information related to the employment advertisement over the network 12, the client terminal 14 can electronically communicate with an employer's processing server 24, which can be maintained by or for an employer seeking to fill an employment position solicited in the employment advertisement provided to the user. The employer's server 24 can provide the user with information regarding the employment advertisement from a jobs database 26, e.g., a job description, a required education level, a required skill set, a salary level, contact information for a hiring coordinator, a geographic location of the job, etc.

The client terminal 14 can include any mechanism or device, or combination thereof, configured to communicate with at least one of the processing servers 16, 20, 24 through the network 12. Examples of the client terminal 14 include a workstation, a stationary personal computer, a mobile personal computer, a server, a personal digital assistant, a pager, a telephone, and other similar mechanisms and devices as will be appreciated by a person skilled in the art. Although only one client terminal is shown in the system 10, the system 10 can include a plurality of client terminals, each associated with one or more users that can simultaneously and/or consecutively access at least one of the processing servers 16, 20, 24 through the network 12.

The processing servers 16, 20, 24 can each include, same or different from any of the other processing servers, any mechanism or device, or combination thereof, configured to communicate with the network 12 such as a file server, an application server, a database server, a mobile computer, a stationary computer, or other similar mechanism or device as will be appreciated by a person skilled in the art. Each processing server can include a processor or any combination of processors configured to process instructions, e.g., a central processing unit, a microprocessor, a digital signal processing unit, application specific integrated circuits (ASICs), a state machine, an analog computer, an optical or photonic computer, logic circuitry, etc., as will be appreciated by a person skilled in the art. Each processing server can also include a memory configured to store and provide instructions to the processor. The memory can include any one or more storage mechanisms. Examples of the memory include random access memory (RAM) such as dynamic RAM or static RAM, read only memory (ROM), flash memory, tapes, disks, buffers, and other types of similar storage mechanisms as will be appreciated by a person skilled in the art. One or more of the processing servers 16, 20, 24 can be combined with at least one of the other processing servers and/or divided into a plurality of processing servers located behind the same or different firewalls. Furthermore, the system 10 can include any number of seller servers associated with any number of sellers and any number of employer servers associated with any number of employers.

The network 12 can include any network, or combination thereof, as will be appreciated by a person skilled in the art, such as an Internet, a local area network (LAN), a wide area network (WAN), a private network, a public network, or other similar network. Communications through the network 12 can be secured with a mechanism such as IP security (IPsec), Transport Layer Security/Secure Socket Layer (TLS/SSL), wireless TLS (WTLS), secure Hypertext Transfer Protocol (S-HTTP), or other similar security mechanism as will be appreciated by a person skilled in the art.

As will also be appreciated by a person skilled in the art one or more of a seller firewall 28, an advertiser firewall 30, and an employer firewall 32 can optionally be disposed in any configuration between the network 12 and each of the processing servers 16, 20, 24, respectively. The firewalls 28, 30, 32 can each include, same or different from any of the other firewalls, any mechanism or device, or combination thereof, configured to help ensure secured network communication. One or more of the firewalls 28, 30, 32 can be combined with at least one of the other firewalls 28, 30, 32. Furthermore, any one or more of the processing servers 16, 20, 24 can be configured for direct communication without use of one or more of the firewalls 28, 30, 32, e.g., communication over a private network. In general, a person of ordinary skill in the art will be able to configure the relationships between servers (and databases) depending upon the commercial or other relationships between the parties who control the servers and/or the data in order to achieve the spirit of the present invention in a secure manner.

The various databases 18, 22, 26 configured to be accessible by one or more of the processing servers 16, 20, 24 can each have a variety of configurations that are the same or different from any one or more of the other databases in the system 10. Examples of the databases include a database, a data queue, a buffer, a local or remote memory device, random access memory (RAM), a cache, or other similar collection of data as will be appreciated by a person skilled in the art. As will be appreciated by a person skilled in the art, the databases can each have any organizational scheme, can each be separated and combined in any way, and can each be located local to or remote from a processing server with which they are associated. Furthermore, each of the databases 18, 22, 26 can be configured to be in electronic communication with any one or more of the processing servers 16, 20, 24 and protected from the network 12 by any of the firewalls 28, 30, 32. By way of non-limiting example only, the advertisement database 22 can be configured, alone or in combination with another database, e.g., the jobs database 26, to be located behind the advertiser firewall 30 and in electronic communication with the advertiser server 20.

Generally, the media materials database 18 can include data related to one or more media materials. The data in the media materials database 18 can include media materials and/or links to media materials available for electronic delivery to the client terminal 14 over the network 12, e.g., electronically readable print files (e.g., postscript files, PDF files, etc.), image files (e.g., JPEG files, GIF files, etc.), audio files (e.g., lossless and/or lossy compressed files), video files (e.g., lossless and/or lossy compressed files), etc. The media materials database 18 can also or instead include catalog information, e.g., titles, authors, ISBN or other identification code information, publication or release dates, etc., for each media material available for ordering by a user over the network 12 via a client terminal and deliverable to a user as a physical item, e.g., a book, an issue of a periodical, an article in a periodical or other collection of articles, a standalone article, a catalog, a CD, a DVD, etc. The media materials database 18 can include any other data related to media materials available to a user, e.g., available quantities, price information, abstracts, annotated summaries, number of citations, author reputation, reader and/or expert comments on bookseller or other websites, level of sales, number of editions, etc., that can be helpful in determining a skill associated with a media material and/or the likely skill level of a user who would consult a particular media material. For example, a media material's table of contents can indicate a media material's likely skill level for one or more skills considering factors such as number of pages per topic, number of chapters on general or easy topics versus number of chapters on specialized or advanced topics, different authors per chapter, etc. A plurality of seller processing servers can be configured to be in electronic communication with the advertiser server 20 over the network 12, and in an exemplary embodiment, each of the seller processing servers is associated with a particular seller, e.g., a particular bookseller website, a particular professional organization, etc., with each seller maintaining or otherwise having its own media materials database including one or more media materials available to a user through that seller.

Generally, the advertisement database 22 can include data related to one or more advertisements available for delivery to a client terminal. In an exemplary embodiment, the advertisement database 22 includes data related to employment advertisements, but the data can relate to any one or more types of advertisements, e.g., university or other education advertisements, advertisements for professional conferences or meetings, periodical subscription advertisements, professional organization membership advertisements, etc., that can be targeted to a user based on the user's selection of a media material, as discussed further below. The advertisement database 22 can include data such as advertisements deliverable to the client terminal 14, e.g., HTML pages, image files, etc. and/or links to advertisements stored elsewhere, e.g., in a separate database. Each of a plurality of seller processing servers that can be configured to be in electronic communication with the advertiser server 20 can maintain or otherwise have its own advertisement database, and/or a central advertisement database can be available for the plurality of seller processing servers, e.g., an advertisement database located behind the advertiser firewall 30 and generally maintained by the advertiser associated with the advertiser server 20 such that the advertiser can add and delete advertisements as desired as they become available or obsolete.

Generally, the jobs database 26 can include data related to one or more employment positions represented in the advertisement database 22 and available with the employer associated with the employer server 24. The jobs database 26 can include data such as job information deliverable to the client terminal 14, e.g., HTML pages, image files, etc. and/or links to employment position data stored elsewhere, e.g., in a separate database. A plurality of employer processing servers can be configured to be in electronic communication with the advertiser server 20 over the network 12, and in an exemplary embodiment, each of the employer processing servers is associated with a particular employer, e.g., particular corporations, particular universities, etc., with each employer maintaining or otherwise having its own jobs database including one or more jobs available through that employer. In this way, an employer can track user requests over the network 12 for information regarding employment opportunities at that employer, can help keep its employment information under internal control, and can update the jobs database 26 with accurate, timely employment information.

The system 10 can include more or fewer elements from those shown, such as one or more storage mechanisms (caches, memories, databases, buffers, etc.), bridges, chipsets, graphics mechanisms, display devices, I/O devices, communication links (e.g., buses, wireless links, etc.), and other similar types of elements that can be included in a system as will be appreciated by a person skilled in the art. PO devices generally include devices configured to transfer data into and/or out of a system, such as mice, keyboards, printers, display devices such as monitors, touch pads, styluses, disk drives, graphics devices, joysticks, paddles, Zip drives, scanners, CD drives, DVD drives, modems, cameras, video devices, microphones, and other similar types of internal, external, and internal/external devices, as will be appreciated by a person skilled in the art.

Furthermore, the methods and systems described herein are not limited to any particular hardware or software configuration; they can find applicability in any computing or processing environment. The methods and systems can be implemented in hardware, software, or a combination of the two. The methods and systems can be implemented in programs executing on programmable machines such as mobile computers, stationary computers, personal digital assistants, and similar devices, as will be appreciated by a person skilled in the art, that each include a processor, a storage medium readable by the processor (including volatile and non-volatile memory and/or storage elements), and at least one input and/or output device or mechanism. Program code can be applied to data entered using the input device or mechanism to perform the functions described and to generate output information. The output information can be applied to one or more output devices or mechanisms.

Each program can be implemented in one or more high level procedural or object oriented programming languages to communicate with a machine system. However, the programs can be implemented in assembly or machine language, if desired. In any case, the language can be a compiled or interpreted language. Non-limiting examples of commercially or publically available products and/or software that can be used to implement the programs discussed herein include Python, PBP, XML, C#, MYSQL, Resource Description Framework (RDF), Web Ontology Language (OWL), Apollo, CIRCA Taxonomy Administrator, CmapTools, COBrA, CoGITaNT, ConcepTool, CONE, Construct, Contextia, COPORUM OntoBuilder, Corese, DAG-Edit, Differential Ontology Editor (DOE), Disciple Learning Agent Shell, DL-workbench, DOGMAModeler, Domain Ontology Management Environment (DOME), DUET, e-COSer—e-COGNOS Ontology Server, Emacs OWL Mode, ExClaim & CommonKADS Workbench, EXPRESS Data Manager VisualExpress, ezOWL, Freedom (formerly Enterprise Semantic Platform), GALEN Intermediate Representation Configurer (GirC), GKB Editor, Haystack, ICOM, InferEd, Integrated Ontology Development Environment (IODE), IsaViz, JOE, KAON IO-modeler, Knowledge Base Editor (KBE) for Zeus Agent Building Toolkit, KBST-EM, K-Infinity Knowledge Builder, LegendBuilder Ontology Editor, LinkFactory Workbench, McCullough Knowledge Explorer (MKE), Medius Visual Ontology Editor, Metis Enterprise, MOMIS Ontology Builder, MR3, NeoClassic, OCW-Ontology Craft Workbench (formerly OntoBuilder), OilEd, OLR3 Schema Editor, Onto-Builder, OntoEdit, Ontolingua with Chimaera, Ontology Editor for Eclipse, Ontology Generator, Ontology Graph (OGraph), Ontology Management System (SNOBASE), OntoMerge, Ontopia Knowledge Suite, Ontosaurus, OntoTerm, OntoTrack, OntoX (of OntoBuilder), OntoXpl, OPCAT-Object-Process CASE Tool, Open Ontology Forge, OpenCyc Knowledge Server, OpenKnoMe, OWL-S Editor, PC Pack 4 (included in SophX-Pack), Protege, Protege OWL Plug-in, RDFAuthor, RDFedit, RIC, Semantica, SemTalk, SMORE, Specware, SUO-KIF Browser, SWOOPed, SymOntoX, Taxonomy Builder, Taxonomy Management System, Terminae, The Discovery Machine, TMTab (Protege), TOPKAT, Triple20, Unicom Workbench (formerly Coherence), Visio for Enterprise Architects, VisualText Conceptual Grammar KB Editor, WebKB, WebODE, WebOnto, Xtractica with Coherent Description Framework (CDF), and other similar types of products and software.

Each such program can be stored on a storage medium or device, e.g., compact disc read only memory (CD-ROM), hard disk, magnetic diskette, or similar medium or device, as will be appreciated by a person skilled in the art, that can be readable by a general or special purpose programmable machine for configuring and operating the machine when the storage medium or device is read by the computer to perform the procedures described herein. The system can also be considered to be implemented as a machine-readable storage medium, configured with a program, where the storage medium so configured causes a machine to operate in a specific and predefined manner.

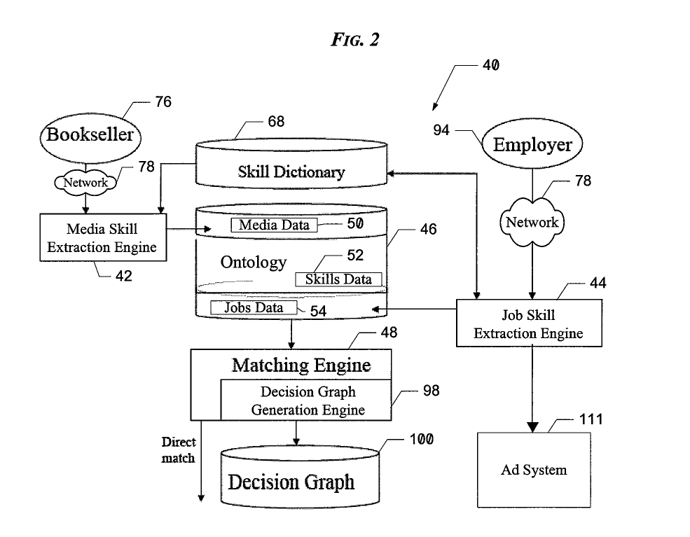

A processing server can include a variety of mechanisms and/or devices integrally formed with the processing server or otherwise accessible to the processing server to help the processing server select a targeted advertisement to be provided to the user at the client terminal 14. FIG. 2 illustrates an exemplary embodiment of an advertising processing system 40 that a processing server, e.g., the advertiser's server 20, can use to help select a targeted advertisement to be provided to the user at the client terminal 14. Generally, the advertising processing system 40 can include a media skill extraction engine 42, a job skill extraction engine 44, and a matching engine 48. The engines 42, 44, 48 are shown as non-limiting examples only, and one or more of the engines 42, 44, 48 can be combined with at least one other engine and/or be divided into a plurality of engines to include various functionalities of advertisement selection as discussed further below.

The advertising processing system 40 can also include one or more collections of data, such as an ontology collection of data 46 and a skill dictionary 68. The skill dictionary 68 can be configured as one or more databases including a collection of skills that can each be associated with a media material, a job, and/or an advertisement. Skills included in the skill dictionary 68 can include specific technical or job related skills, examples of which are provided below and in the figures. In some embodiments, they will be technical skills relating to computer hardware and software, or more generally, skills related to information technology. However, the skill dictionary 68 can also or instead include demographic attributes that might be important to employers, aptitude attributes that may relate to a user's ability to learn new skills, or even psychographic attributes such as attributes relating to personality, values, attitudes, interests, or lifestyles where those attributes might be of interest to an employer. In an exemplary embodiment, the skill dictionary 68 can be organized as a list, e.g., an alphabetical list. The skill dictionary 68 can be configured to include thesaurus type functionality that allows the skill dictionary 68 to associate related words (where “words” includes single words and multi-word phrases), e.g., synonymous words, reified words, abstractly associated words, etc., such that the ontology collection of data 46 either includes only one of each set of related words or freely associates related words when analyzing skills as discussed further below.

The ontology collection of data 46 can generally be configured as a depository of data and include a media materials collection of data 50, a skills collection of data 52, and a jobs collection of data 54. Each of the collections of data 50, 52, 54 can have any type of organization, same or different from any one or more other collections of data, such as a list or an ordered set, but in an exemplary embodiment, each of the collections of data 50, 52, 54 is organized as a database table representing a directed acyclic graph (DAG), each DAG having a plurality of nodes. Generally, a node can be associated with a media material, an employment skill, or an employment position. Edges between nodes can model association or anti-association between nodes and have labels indicating a strength of the association or anti-association, as discussed further below.

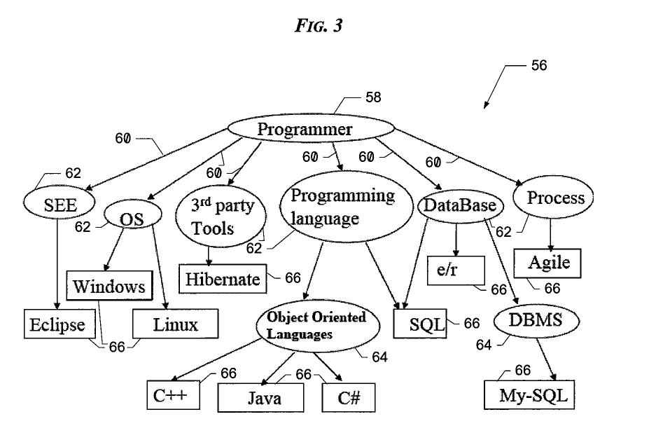

FIG. 3 illustrates an exemplary embodiment of a jobs graph 56 that can be included in the jobs collection of data 54. The jobs graph 56, by way of non-limiting example only, shows an ontology for a programmer job represented by a job type node 58. The job type node 58 can have one or more edges 60 connecting or associating the job type node 58 with one or more skill type nodes 62, each skill type node 62 representing a job skill associated with the programmer job type represented by the job type node 58. In this illustrated example, the skills associated with a programmer include a software engineering environment (SEE) skill, an operating system (OS) skill, 3rd party tool skill, programming language skill, database skill, and process skill. Each of the skill type nodes 62 connected by an edge to the job type node 58 can be an abstract skill with one or more compounded skill nodes 64 and/or basic skill nodes 66 “downstream” of each abstract skill node. Any skill nodes “downstream” of a given skill node are a subset of that given skill node, e.g., are children of that parent skill node. A basic skill node preferably does not have any “downstream” nodes. For example, as illustrated in FIG. 3, the programming language skill node is “upstream” of an SQL basic skill node and an object oriented languages compounded skill node. A compounded skill node 64 can have one or more “downstream” edges connecting it to one or more basic skill nodes associated with that compounded skill, e.g., C++, java, and C# being basic skills of the object oriented languages compounded skill. Each node can have any number of associated “upstream” and/or “downstream” edges leading to or from it, including zero, e.g., when a skill has been entered into the skill dictionary 68 as a possible job skill but is not currently associated with at least one job type node. For example, the SQL basic skill node has two “upstream” nodes and zero “downstream” nodes while the programming language abstract skill node has one “upstream” node and two “downstream” nodes.

As mentioned above, each of the edges in a DAG can have an associated strength. In an exemplary embodiment, in the media materials collection of data 50 and the jobs collection of data 54, the strength is defined as an n-tuple, where “n” can equal any whole number. In an exemplary embodiment, “n” equals 2, with the 2-tuple including a skill level (l) and a skill desirability (d) and being represented as (l, d). The skill level l can indicate complexity of a skill, e.g., a level of expertise such as beginner, moderate, expert, etc., while the skill desirability d can indicate the importance of a particular skill type node to the node “upstream” of it. For example, as illustrated in FIG. 3, the SQL node can have a strength of (3, 8), with three indicating an expert skill level on a scale of one to three (with three indicating a most advanced skill) and with eight indicating a desirability on a scale of one to ten (with ten indicating most desirable). As will be appreciated by a person skilled in the art, any scale can be used for each of l and d, and l and d can be represented alphabetically and/or numerically.

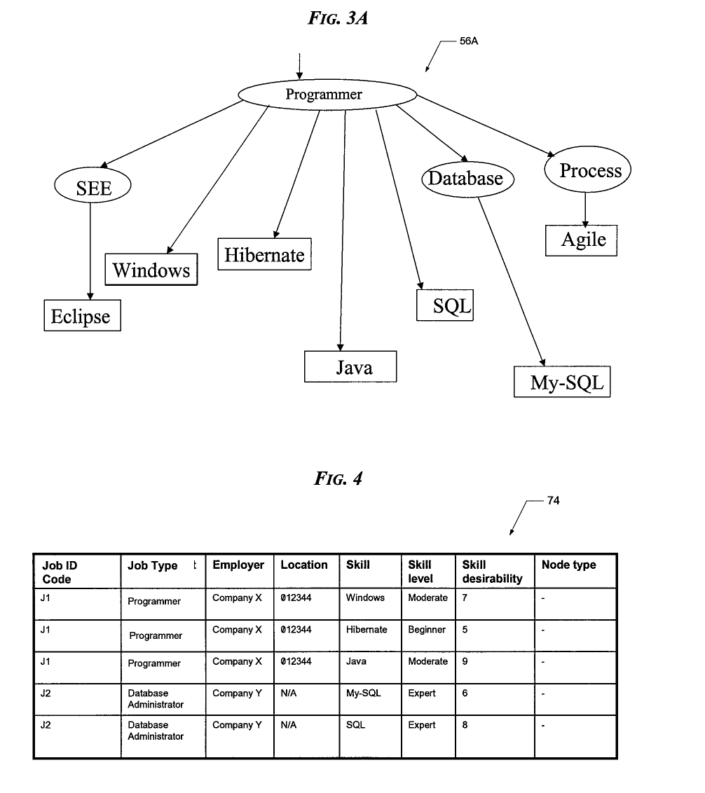

FIG. 4 illustrates one illustrative example of an excerpt of the jobs graph 56 of FIG. 3 as a jobs table 74 that can be stored in the jobs collection of data 54. The jobs table 74 indicates associations between various nodes in the jobs graph 56 and corresponding node strengths, where the job type node 58 has job ID code J1.

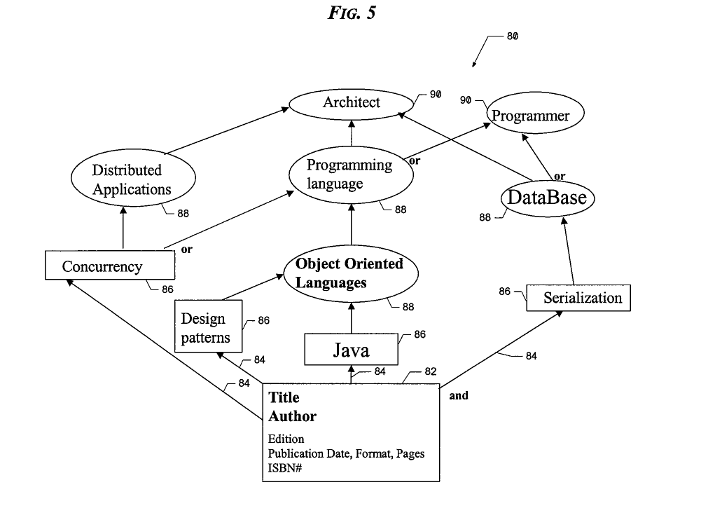

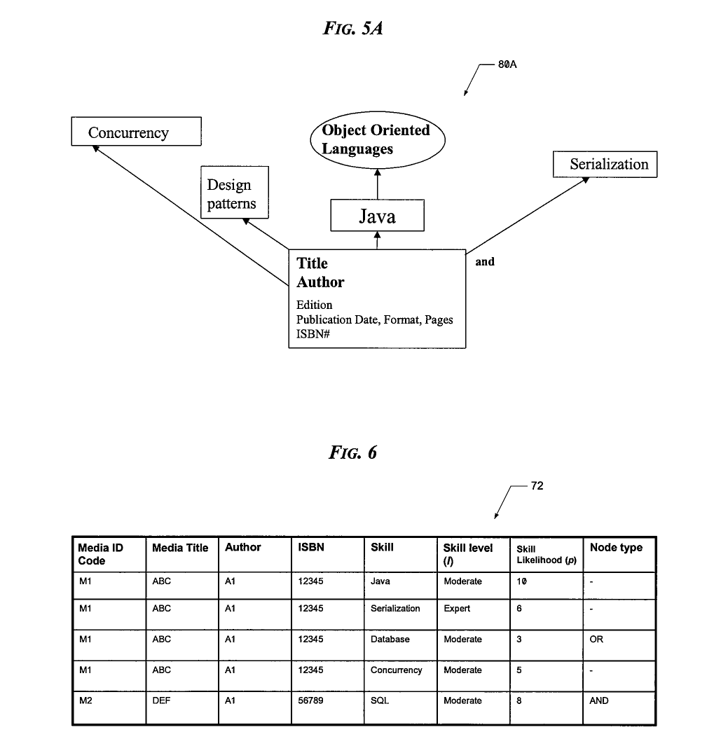

FIG. 5 illustrates an exemplary embodiment of a media graph 80, similar to the jobs graph 56, that can be included in the media materials collection of data 50. The media graph 80 shows, by way of non-limiting example only, an ontology for a book represented by a book node 82, but a media graph can be for any type of media material. The book node 82 includes identification data related to a particular media material, e.g., title, author(s), editor(s), edition number, volume number, publication date, media format (e.g., paperback, hardcover, audio, etc.), number of pages, ISBN, etc. At least some identification data can be obtained for at least some media materials, particularly books, through sources such as Bowker Books-in-Print of New Providence, N.J. and Nielsen BookScan US of White Plains, N.Y. The book node 82 has one or more edges 84 connecting or associating the book node 82 with one or more skill type nodes 86. Similar to that discussed above regarding the jobs graph 56, each of the skill type nodes 86 in the media graph 80 can identify a job skill associated with the book represented by the book node 82. As illustrated, the skill type nodes 86 can also each have any number of edges connecting or associating them with one or more “downstream” skill type nodes 88, with each “downstream” skill type node 88 generally representing a skill more specific than the one or more skill type nodes “upstream” of it. When a skill type node reaches a certain level of specificity, the skill type node can be associated by an edge with one or more particular job types represented in the media graph 80 by one or more job type nodes 90. For example, as illustrated, the distributed applications skill node has an edge associating it with an architect job type node.

FIG. 5 also shows that a DAG's nodes in the ontology collection of data 46 can have a variety of types, e.g., Boolean types including an AND type, an OR type, or a NOT type. An AND type node is associated with each of the nodes connected by an edge one level “downstream” of it. An example of an AND type node is illustrated as the book node 56 associated with all of the skill type nodes 86 representing the skills concurrency, design patterns, Java, and serialization. An OR type node is associated with at least one of the nodes connected by an edge one level “downstream” of it. An example of an OR type node is illustrated as the database skill node associated with at least one of the job type nodes 90 representing architect and programmer. A NOT type node indicates an anti-association with each of the nodes connected by an edge one level “downstream” of it, e.g., to indicate that a particular skill node is not associated with a particular job type node or media type node.

Also similar to that discussed above, each of the nodes in the media graph 80 can have an associated strength. In an exemplary embodiment, nodes in a media graph include a skill level (l), discussed above, and a probability (p), which indicates the confidence level, probability, or likelihood that the “downstream” node of an edge is associated with the “upstream” node of the edge, which in turn can indicate the confidence level, probability, or likelihood that the user possesses a skill at the associated skill level. For example, as illustrated, the node 82 and the Java skill node can have a strength of (2, 10) indicating a moderate skill level on a scale of one to three (with three indicating a most advanced skill) and with ten indicating a very high probability on a scale of one to ten (with ten indicating most likely). As will be appreciated by a person skilled in the art, any scale can be used for p, and p can be represented alphabetically and/or numerically.

FIG. 6 illustrates an excerpt of the media graph 80 of FIG. 5 as a media table 72 that can be stored in the media collection of data 50. The media table 72 indicates associations between various nodes in the media graph 80 and corresponding node strengths, where the book node 82 has media ID code M1. Entries in the media table 72 can be dynamic, e.g., they can change over time. For example, the older the publication date of a media material, the more likely that the media material has decreased in skill level and the media material's skill level can be manually and/or automatically adjusted accordingly. The first edition of a book may have an expert skill level, but as the information in the book permeates into the relevant field, that information becomes more common, and the book's skill level can be manually and/or automatically decreased from expert to moderate after an amount of time, e.g., six months, and from moderate to beginner after a subsequent amount of time, e.g., eighteen months. Alternatively, the information in the book can become obsolete and not indicate any particular skill level at all after a certain amount of time, e.g., two years, and can be decreased to a beginner skill level or be marked as an obsolete skill not likely to be given any weight in determining matches between the media material and jobs. As another example, a new edition of a media material can increase the media material's skill level. As still another example, media nodes can be deleted from the media data 50, e.g., if a media material goes out of print.

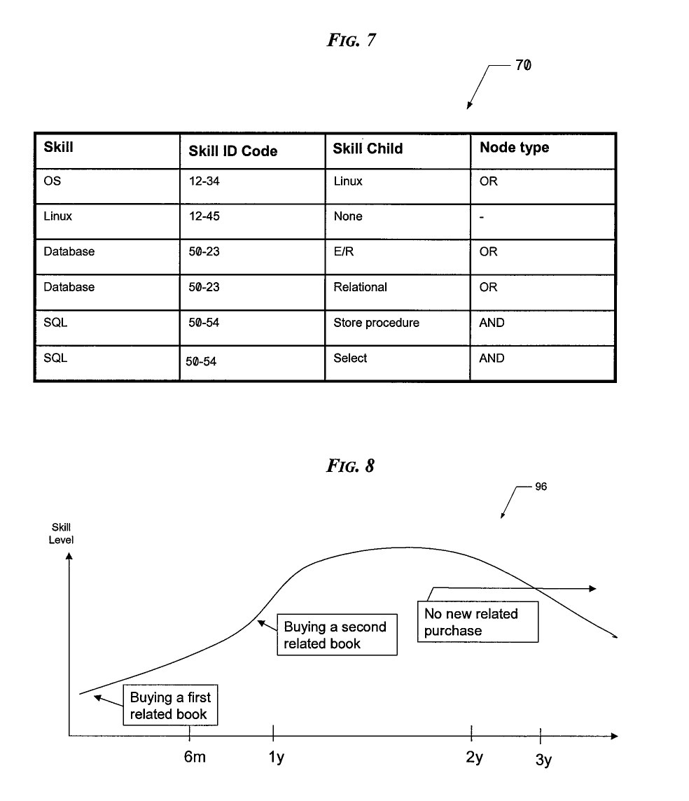

The skills collection of data 52 can also include DAGs for skills that are similar to the illustrated jobs graph 56 and media graph 80. FIG. 7 illustrates an exemplary embodiment of a skills table 70. Entries in the skills table 70 can be dynamic. For example, an administrator can use a skill entry utility to change definitions in the skills collection of data 52 and/or to enter, modify, and/or removes skills in the skills collection of data 52 or the skill dictionary 68.

Generally, the media skill extraction engine 42, the job skill extraction engine 44, and the matching engine 48 can be configured to process instructions related to nodes included in the ontology collection of data 46. The media skill extraction engine 42 can be configured to process instructions related to media materials available for acquisition by a user and skills associated with the media materials. For an available media material, the media skill extraction engine 42 can process data related to the media material and transmit data to the ontology collection of data 46, which can store the data in, e.g., the media materials collection of data 50.

Data can be input to the media skill extraction engine 42 manually and/or automatically. One or more people can manually input media material data in the media materials collection of data 50. For example, a bookseller 76 can input media material data to the media skill extraction engine 42, e.g., over a network 78, such as the network 12 using the seller's server 16. The bookseller 76 can in some embodiments be electronically presented with a media questionnaire via web browser asking for basic book identification information, e.g., title, author, etc. For each new media material, which can be identified as new using an identification code such as an ISBN, the media questionnaire can permit the bookseller 76 to enter one or more associated skills with their corresponding skill levels, and optionally a direct correspondence to a job, e.g., job title, job type, etc. The media questionnaire can be linked to the skill dictionary 68 to help reduce errors in entering skills and encourage consistency between skills entered for various media materials, e.g., by resolving any issues with synonyms, by performing reification of skills, identifying skills that do not already exist in the skill dictionary 68, etc. Each new input media material can result in a new media node corresponding to that media material and having edges and related nodes as identified in the media questionnaire. Media material data can be edited at any time, such as to add or delete skills, add or delete job types, to correct input errors, to edit skill strength, etc. In an exemplary embodiment, only an authorized user, e.g., a user identified by login name and password, can access the media skill extraction engine 42 and be permitted to add and/or edit media data. In addition to or instead of manual media material data collection, the media skill extraction engine 42 can be configured to automatically generate media data for a media material, e.g., by identifying a keyword in the media material's title, abstract, table of contents, index, navigational data (e.g., URL, link used to access a media material, etc.), or other similar data and using the keyword to associate a skill and/or a job type with that media material.

The job skill extraction engine 44 can be configured to process instructions related to jobs available for advertisement to a user and skills associated with the jobs. Although the job skill extraction engine 44 is described with reference to jobs, the job skill extraction engine 44 can be configured to process instructions related to any one or more categories of advertisements (e.g., university programs, professional conferences, professional training sessions, etc.) that the system 40 can provide to a user. For an employment position associated with an advertisement, the job skill extraction engine 44 can process data related to the employment position and transmit the data to the ontology collection of data 46 which can store the data in, e.g., the jobs materials collection of data 54, and transmit a request to store a new advertisement in the advertisement database 22.

Similar to the media skill extraction engine 42 discussed above, data can be input to the job skill extraction engine 44 manually and/or automatically. For example, a recruiter or an employer 94 can input job data to the job skill extraction engine 44 over the network 78, e.g., over the network 12 using the employer's processing server 24. The employer 94 can be electronically presented with a job listing editor via web browser that permits the employer 94 to build a candidate profile including job data for an available job, e.g., job title, required and/or desirable skill(s), breadth and depth of expertise desired (e.g., skill level, skill desirability, etc.), maximum physical distance from a geographic location of the employment position, possibility or not for relocation expense compensation, etc. The job listing editor can allow the employer 94 to select job titles to be listed and to assign skills and level of expertise to each listed title. The job listing editor can also allow the employer to identify a specific industry or domain area of expertise that is associated with a job (e.g., for a computer programming job, experience in the financial services industry). The job listing editor can control that any term, e.g., job title, skill, etc., already exists in the skill dictionary 78. A new term can either be identified as related to a term existing in the skill dictionary 78 or be identified as new and added to the skill dictionary 78 and be a new DAG node. In this way, the skill dictionary 78 can be dynamic and can include “real world” job skills associated with actual employment positions such that media materials can be associated with skills in the skill dictionary 78 that are or have been actually identified with “real world” jobs to help establish correlations between media materials and jobs.

The matching engine 48 can be configured to process instructions related to analysis of one or more media materials selected for acquisition by a user and identifying relevant prospects for job advertisements available for delivery to the user using the system 40. The matching engine 48 can perform at least a portion of its analysis in real time using data stored in the ontology collection of data 46 to help quickly identify an appropriate advertisement to display to a user while the user is shopping for or has purchased a media material. The advertisement can be displayed to the user in any way, e.g., on a final checkout web browser page, on an order confirmation web checkout page, in an order confirmation email, etc. Moreover, the advertisement can be displayed to the user on a web page associated with the seller, the advertiser, and/or a third party (e.g., a designated third party payment collector for the seller).

In an exemplary embodiment, analysis performed by the matching engine 48 can include but is not limited to propagation, comparison, and resolution. Propagation, comparison, and resolution are described in more detail below, but propagation generally includes determining one or more skills associated with a media material and determining one or more skills associated with a job type, comparison generally includes identifying a job advertisement that correlates to a media material selected for acquisition by a user, and resolution includes determining which one or more identified job advertisements to display to a user considering one or more media materials contemporaneously and/or previously selected for acquisition by the user.

Propagation performed by the matching engine 48 can include determining skill relationships in a jobs table or graph in the jobs data 54 in the ontology collection of data 46 and/or in a media table or graph in the media data 50 in the ontology collection of data 46. In a jobs graph, e.g., the jobs graph 56 of FIG. 3, the matching engine 48 can propagate skills “upstream.” If a media material is associated with a particular skill node in the jobs graph, then the media material is also necessarily associated with the skill node(s) connected by edges “upstream” of that skill node. For example, as illustrated in a pre-propagation jobs graph 56A in FIG. 3A and in the post-propagation graph 56 of FIG. 3, if a media material is associated with the C++ skill node, the matching engine 48 can propagate skills for that media material to also include the object oriented languages skill node and the programming language skill node, which are both “upstream” of the C++ skill node. In other words, the C++ skill node is a subset of object oriented languages, which is a subset of programming language, so having skill with C++ necessarily indicates having skill with object oriented languages and with programming language. The matching engine 48 can add entries in job table(s) as appropriate based on skill propagation. The matching engine 48 can similarly propagate skills in a media graph, e.g., a pre-propagated media graph 80A shown in FIG. 5A to the propagated media graph 80 of FIG. 5, and add appropriate entries for propagated skill(s) in media table(s). For example, as illustrated in FIG. 5, the distributed application skill node can be propagated to the concurrency skill node. The matching engine 48 can consider a skill node's type, e.g., AND, OR, etc., in propagating skills. For example, as shown in FIG. 5, the concurrency skill node indicates a related skill in distributed applications or in programming language. The propagation can also propagate strength using rules to set values to added skill nodes.

Comparison performed by the matching engine 48, preferably performed after propagation, can include determining a match between a media material selected for acquisition by a user and an advertisement to display to the user based at least on a common association of skills associated with the selected media material and with the advertisement. The matching engine 48 can examine the media data 50 and the job data 54 in the ontology collection of data 46 to look for matches in skills between a user-selected media material and jobs available for advertisement to the user. In an exemplary embodiment, the matching engine 48 can locate one or more matches in the job data 54 for a given media material included in the media data 50. The matching engine 48 can generate for each located match a score, weight, or confidence level, such as by assigning each match an amount of numerical points based on the strength (l, d) associated with a common skill between the media material and a job. A matching skill, e.g., SQL, DBMS, programming languages, etc., can score a certain number of points, a matching skill level l for that skill can acquire additional points, and the desirability d of that skill can also increase the match's point total where the higher the desirability d the more points accorded that match. The matching engine 48 can also deduct points from a job's total if a NOT type node is associated with the job, e.g., if a media material is associated with a skill included as a NOT type node in the DAG for the job. Points can also be deducted if a level mismatch is found. When a particular job in the job data 54 acquires a weight above a certain threshold value or qualifying score, e.g., by scoring enough points by through one or more matching skills with a user-selected media material, through being located within a certain distance of the user's geographic location, etc., then the matching engine 48 can select that job for advertisement to the user who selected that media material. The matching engine 48 can stop searching for a selected advertisement after locating one job with a score above the threshold value, or the matching engine 48 can continue analyzing data to possibly locate one or more additional jobs having scores above the threshold value. If the matching engine 48 identifies two or more jobs having point totals above the threshold value, then resolution performed by the matching engine 48 can determine which of the jobs to advertise to the user and/or in which order to provide to the user. In some embodiments, a plurality of identified job advertisements can be provided to the user and resolution may therefore not be necessary or may be used to determine how to provide the advertisements, e.g., a layout of the plurality of identified advertisements. The matching engine 48 can electronically transmit an advertisement identifier or other appropriate trigger to the processing server associated with an employment advertisements system 111, e.g., a system including the jobs database 26, to transmit the selected job advertisement to the user.

If a user selects to acquire a plurality of media materials, the matching engine 48 can determine a matching job for each of the media materials. The identified job may or may not be the same for each of the user-selected media materials. If the identified job is not the same for each of the media materials, resolution performed by the matching engine 48 can include determining a best match among the identified jobs as the one to advertise to the user. Such resolution can include the matching engine 48 selecting the identified job having the highest point total or further analyzing the selected jobs. Resolution can optionally involve the matching engine 48 overruling the scoring function and selecting the identified job having a skill level mismatch, e.g., in the case of skill rarity. In further analyzing the selected jobs, the matching engine 48 can consider one or more additional factors related to the user such as the user's geographic location, the user's previous media material purchase history, media materials the user has browsed in this or a previous browsing session, media materials returned in a search of media materials requested by the user, media materials the user has not purchased but has tagged or otherwise marked for future purchase (e.g., by placing a media material in a virtual shopping cart), relationship between the selected media materials (e.g., similar topics of books indicating a skill level above beginner, books on various topics indicating a probable managerial skill, etc.), rarity of the user's selected media materials (e.g., increasing weight associated with more rarely selected media materials), rarity of the selected jobs (e.g., increasing weight associated with more rarely selected advertisements), etc. Such factors can increase or decrease a selected job's point total or score and allow the matching engine 48 to subsequently select the job having the highest point total or score.

In some embodiments, whether the user has currently selected acquisition of a single media material or a plurality of media materials, the matching engine 48 can consider a user's previous media material acquisition history and consider skills associated with one or more of the user's previously selected media materials in determining which of a plurality of identified jobs to advertise to the user. For example, if a user previously purchased a first book having a particular expert skill level but is currently purchasing a second book associated with that same skill at a beginner level, the matching engine 48 can conclude that the user is a beginner rather than an expert because, e.g., the user initially overconfidently purchased too advanced a book, and accordingly accumulate points based on skill level such that beginner employment positions receive higher points than expert employment positions. As another example, the matching engine 48 can consider an amount of time that has elapsed since a user purchased a particular media material in assessing confidence of a likely skill level of the user and assigning points to matches accordingly. As illustrated in an embodiment of a user skill graph 96 in FIG. 8, e.g., a model of a user's skill evolution over time, a user at time 0 can buy a media material having a certain skill level and then approximately one year later buy another media material having a related or same skill having higher skill level. The user can learn from the book and through other related experience and increase in skill level over time, but that skill level can decrease as time passes, e.g., two or three years beyond the initial media material's purchase, as the user's skills decline or become outdated if the user does not purchase (or browse or save for later purchase) another related media material (at least not as known to the matching engine 48). The matching engine 48 can thus downgrade, or eventually ignore, the user's skill level as time passes without an additional media material purchase related to a particular skill or set of skills and assign points accordingly. The matching engine 48 can upgrade or downgrade the level of confidence of such a skill using a similar model. The matching engine 48 can consider a user's previous media material acquisition history with one seller (e.g., one online bookseller, one professional organization, etc.) or with a plurality of sellers. The ontology collection of data 46 and/or other database(s) can optionally store and supply the matching engine 48 with user profile data indicating the user's previous media material acquisition history.

In some embodiments, whether the user has currently selected acquisition of a single media material or a plurality of media materials, the matching engine 48 can consider a user's geographic location in selecting an advertisement for display to the user. In this way, an advertisement displayed to a user can be more likely to attract the user's attention and interest because local employment positions are generally more realistic and appealing to a potential candidate than employment positions requiring relocation. Although, as mentioned above, an employer can indicate that an employment position includes relocation expense reimbursement, which the matching engine 48 can factor in to a remote employment position's score despite the position not being within a geographic region of a potential candidate, e.g., as indicated by the user's Internet Protocol (IP) address, the user's zip or other postal code as provided to the selected media material's vendor, etc.

The matching engine 48 can optionally consider one or more disqualifying rules in performing its comparison and/or resolution. One example of a disqualifying rule is a user's contemporaneous purchase of multiple copies of the same media material, which indicates that the user is likely not purchasing the media materials for their own use. Rather, the user may be an administrator buying books for a corporate library, for various employees, for distribution to students, or for any other use by someone other than the user purchasing the media materials. Therefore, if the user selects acquisition of multiple copies of the same media material, the matching engine 48 can determine that the user likely does not possess skills associated with that media material and deduct points accordingly if not entirely disqualify that media material from consideration in selecting an advertisement to display to the user. Another example of a disqualifying rule includes a job being disqualified from being selected by the matching engine 48 if the job's geographic location is beyond a certain distance from the user's geographic location. Another example of a disqualifying rule is using the lowest skill level of any one or more user-selected media materials as the likely skill level for the user. This rule reflects the tendency of some users to select a more advanced media material in addition to a lower level media material in anticipation of future learning. In this way, selecting a “beginner” media material can disqualify a user from being considered an “expert,” even if the user also selects an “expert” media material, and receiving an advertisement above his or her actual skill level. Still another example of a disqualifying rule is allowing a given skill level to disqualify a user for one or more lower skill levels. This rule can help prevent the user from receiving an advertisement below his or her skill level, e.g., prevent the user from receiving an entry level programming job advertisement when the user is buying an expert level book on programming even though the user does likely have the necessary skills for the entry level programming job based on the user's purchase of the book on programming.

The matching engine 48 can perform propagation, comparison, and/or resolution offline (e.g., prior to a user's media material selection) and/or in real time. For example, the matching engine 48 can perform at least some functions offline to help save time in the typically limited amount of time available during a user-seller transaction to, e.g., update the system if there is a change in any media material, skill, or job independent from a transaction with a user. For another example, the matching engine 48 can perform propagation, comparison, and resolution in real time after a user has confirmed acquisition of a media material, e.g., submitted payment for a media material. As another example, the media skill extraction engine 42 can extract skills from a media material selected for acquisition by a user in real time and the matching engine 48 can perform propagation, comparison, and resolution in real time after a user has confirmed acquisition of a media material, e.g., submitted payment for a media material. By performing at least a portion of its analysis in real time, the matching engine 48 need not perform analysis of a particular media node and use associated resources to perform such analysis until the media node is implicated by user media material selection. Furthermore, by performing analysis in real time, the most current data stored in the skill dictionary 68 and the ontology collection of data 46 can be used by the matching engine 48 for advertisement selection purposes.

As another example, real time performance of the matching engine 48 can be improved with an optional batch mode that includes a decision graph generation engine 98 configured to allow the matching engine 48 to perform propagation and comparison before a user confirms acquisition of a media material, e.g., before a user purchases a media material. Generally, with decision graph generation, the matching engine 48 can determine for one or more media materials stored in the media data 40 a job to select for advertisement and/or a job disqualified for advertisement to a user when a user selects acquisition of a particular media material. The matching engine 48 can store generated decision graphs in a decision graph collection of data 100. The decision graph collection of data 100 can have any type of organization, same or different from any one or more other collections of data in the system 40, but in an exemplary embodiment, the decision graph collection of data 100 is organized as a database table representing a DAG having a plurality of nodes.

FIG. 9 shows an embodiment of a decision graph 102 that can be generated by the matching engine 48 via the decision graph generation engine 98 and stored in the decision graph collection of data 100. The illustrated decision graph 102 includes a bipartite graph showing relationships between a plurality of media nodes 104 and a plurality of job nodes 106 where edges between various nodes 104, 106 indicate relationships between the edge-connected nodes.

Each edge between a media node 104 and a job node 106 pair indicates that those two nodes 104, 106 have a matching skill having a certain strength (l, d) that is preferably predetermined, e.g., pre-calculated. Edges between media nodes 104 and job nodes 106 can have a variety of types indicating an edge's strength, such as selection edges 108, point edges 110, and disqualifying edges 112.

Each media node 104 can have a selection edge 108 that generally indicates a qualifying score or strength has already been reached for that media node 104 and thus that the job node 106 associated with the selection edge 108 should be the one selected by the matching engine 48 for a user's selection of that media material. For example, a user's selection of Book1 can cause the matching engine 48 to select an advertisement for Job2 and not for Job1 even though Book1 is also associated with Job1 by an edge. A media node 104 can have a plurality of selection edges 108.

Each media node 104 can include any number of point edges 110 that generally indicate a matching skill between a media material and a job that the matching engine 48 can accord points to in determining which job to select for a given media material. A point edge 110 can turn into a selection edge 108 between a given media node 104 and a given job node 106 when the matching engine 48 has determined that one of the job nodes has the highest score or is otherwise the most desirable job node to select for the given media node. The point edges 110 can help indicate the potential for the matching engine 48 to select a particular job node. For example, job nodes 106 for Job1, Job3, and Job7 will not be selected by the matching engine 48 because they do not have adequate point totals, with Job1 only being associated with Book1 which has a higher point total for Job2, with Job3 only being associated with Book2 which has a higher point total with Job2 and possibly Job4, and with Job7 having no point edges at all. The point edges 110 can also be used by the matching engine 108 to determine which of the job nodes 106 to select if a user selects acquisition of multiple media materials. For example, if a user buys Book2 and Book3, the matching engine 48 can select Job4 because both Book2 and Book3 have point edges 110 connected to Job4 that together can result in a higher point total for Job4 than for any of the other jobs associated with either Book2 or Book3.

Each media node can include any number of disqualifying edges 112 that generally indicate a disassociation between a given media node 104 and a given job node 106, e.g., if an employer specifies such a disassociation. For example, a user's selection of Book4 can disqualify the matching engine 48 from selecting Job5, even if the user has also selected to acquire Book3 which has a selection edge 108 connecting Book3 and Job5.

A media node 104 can be connected or associated with any number of job nodes. A media node 104 having no associated edges, such as with the media node 104 for Book5, indicates that the media material for that node does not have a matching skill with any of the currently available jobs represented by the job nodes 106. If the user selects acquisition of such a zero-edge media material, the matching engine 48 can select a job advertisement to provide to the user based on one or more other considerations, e.g., the user's geographic location, one or more other media materials currently or previously purchased by the user, etc., or not select any job advertisement for display to the user.

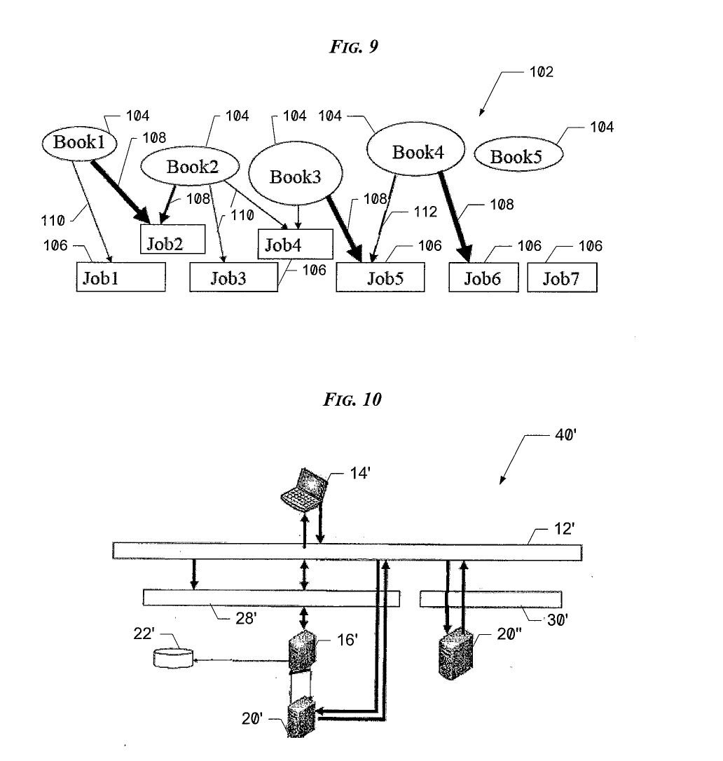

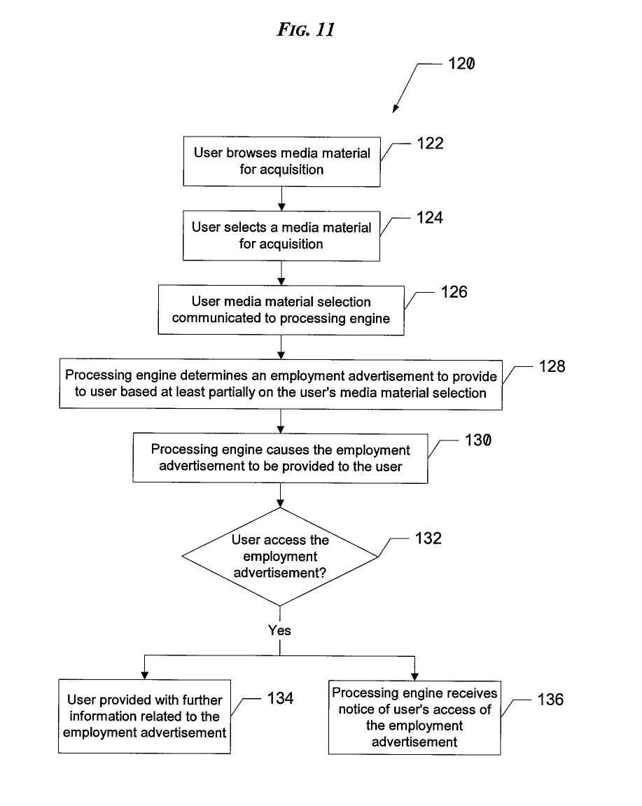

Although the system 40 is described with respect to and as located advertiser-side at the advertiser's server 20, the system 40 can be located advertiser-side, seller-side, and/or employer-side and can be distributed between any one or more processors advertiser-side, seller-side, and/or employer-side. In another embodiment of a system 40′ shown in FIG. 10, an advertiser's server can be configured to be divided into two processing servers, a rules engine processing server 20′, located behind a seller's firewall 28′ and in electronic communication with a seller's processing server 16′, and a rules generation processing server 20″ located behind an advertiser's firewall 30′. An advertisement database 22′ can be located behind the seller's firewall 28′ and be in electronic communication with the seller's server 16′.

Generally, in the system 40′, the rules generation processing server 20″ can be configured to periodically receive updates regarding advertisements for available job positions, such as a new job advertisement. notification that a job advertisement is outdated because the job is no longer available, etc. The rules generation processing server 20″ can be configured to transmit such updates as a batch feed through the advertiser's firewall 30′, over a network 12′, and through the seller's firewall 28′ to be included in the advertisement database 22′. The rules generation processing server 20″ can also be configured to transmit new rules updates to the seller's server 16″ corresponding to the advertisement updates. Buyers at client terminals 14′ can browse media material for purchase over the network 12′ from the seller. When a buyer decides to purchase a media material from the seller, e.g., by sending a purchase order to the seller's server 16′ via the network 12′, the rules engine processing server 20′ can determine an advertisement from the advertisement database 22′ for the seller's server 16′ to provide to the buyer. The rules engine processing server 20′ can also be configured to transmit statistical and trace information about media material and job matching and user activity regarding ads provided to the users (e.g., whether a user did or did not click on an ad for further information, etc.) to the rules generation processing server 20″, which can allow the rules generation processing server 20″ to analyze advertisement efficiency, user preferences, matching engine efficiency, and/or other helpful statistical information that can, e.g., help adjust edge strengths in one or more DAGs.

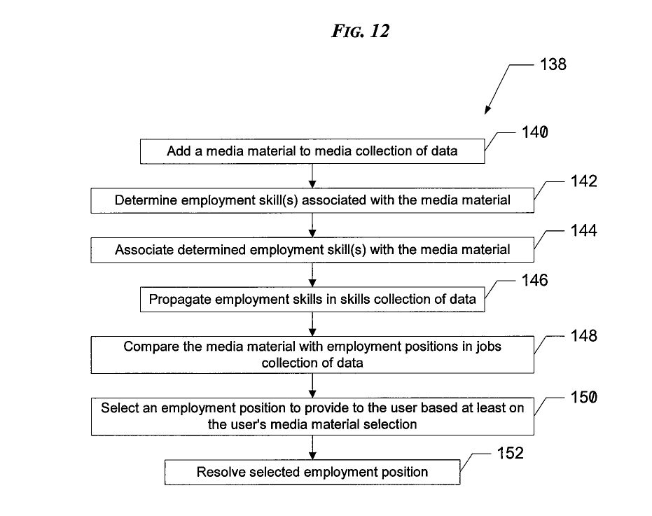

FIGS. 11 and 12 illustrate an exemplary embodiment of providing a user who selects acquisition of a media material with a targeted advertisement using the functionality provided by the advertiser's server 20 (or any one or more other processors as discussed above). Although FIGS. 11 and 12 are described with reference to the elements included in the embodiments of the systems shown in FIGS. 1 and 2, this or a similar process, including the same, more, or fewer elements, reorganized or not, can be performed using the system 10, the system 40, and/or other, similar systems, as will be appreciated by a person skilled in the art.

In use, as shown in FIG. 11, a targeted advertisement process 120 can include a user at the client terminal 14 browsing 122 media material available for acquisition (e.g., purchase, download, mailing, or otherwise accessing the media material through any transaction that generates data that can be tracked) from a vendor associated with the seller's server 16. The user via the client terminal 14 can select 124 a media material for acquisition, e.g., by adding a media material to a virtual shopping cart maintained by the seller's server 16, submitting a purchase order for a media material to the seller's server 16, clicking on a link or other navigational mechanism to read a particular web page, commenting on a blog post, providing a review of a product, etc. The seller's server 16 can process the user's acquisition request in any way appropriate for the seller. The seller's server 16 can also communicate 126 the user's media material selection to the advertiser's server 20, which can determine 128 an employment advertisement, if any, to provide to the user at the client terminal 14 based at least partially on the user's selected media material.

FIG. 12 illustrates an embodiment of an employment advertisement selection process 138 that the advertiser's server 20 can use to determine 128 an employment advertisement to provide to the user at the client terminal 14. If the media material selected by the user is not already included in the media data 50 in the ontology collection of data 46, the advertiser's server 20 can add 140 the user-selected media material to the media data 50, e.g., temporarily or permanently add a media node for the media material in the media data 50. The advertiser's server 20 can also optionally receive and/or generate 142 one or more employment skills associated with the user-selected media material, and if such employment skill(s) are not already included as nodes connected to or associated with the newly added media node in the media data 50, the advertiser's server 20 can associate 144 the employment skill(s) with the media material's media node or can ignore the employment skill(s) as not associated with any jobs. The advertiser's server 20 can also propagate 146 the newly received and/or generated skills in the ontology collection of data 46. With an entry for the user-selected media material in the media data 50 and skills associated with the user-selected media material propagated, the advertiser's server 20 can compare 148 the user-selected media material with employment positions available for advertisement included in the jobs data 54 and select 150 one or more of the advertisements for display to the user at the client terminal 14. Optionally, the advertiser's server 20 can resolve 152 the selected advertisement(s) with respect to one or more additional factors, e.g., user's geographic location, user's concurrently purchased media materials, etc.

Referring again to FIG. 11, having selected one or more advertisements to provide to the user, the advertiser's server 20 can cause 130 the selected employment advertisement(s) to be provided to the user at the client terminal 14. The user can optionally access 132 additional information regarding the displayed employment advertisement, e.g., by clicking via mouse and web browser on an image displayed on the client terminal 14. In this way, an advertisement selected for a user can be provided after a transaction and generally not affect the transaction between the user and a seller. If the user so chooses to receive additional information, the user can be provided 134 with further information related to the accessed employment advertisement, e.g., by opening a new browser window showing an informational web page stored in the jobs database 26 and maintained by the employer associated with the accessed employment advertisement. The advertiser's server 20 can optionally receive 136 notice of the user's access of the employment advertisement to help the advertiser maintain a record of user advertisement interaction that can help the advertiser collect referral fees from the employer. Additionally or alternatively, other statistical data regarding the advertisement selected by the matching engine 48 and provided to the user at the client terminal 14 can be stored in the ontology collection of data 46 and/or elsewhere to help analyze various factors such as advertisement selection frequency and user advertisement interaction and/or to help support optimization of the ontology such as by tuning various strengths and changing rules used by the confidence level scoring function or in propagation.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A method of providing targeted advertisements, comprising:
associating in an electronic database at least one employment skill with each of a plurality of employment positions;
associating in an electronic database at least one employment skill with each of a plurality of media materials a user can acquire through a transaction at least partially transacted over a network; and
selecting an employment advertisement to provide over a network to a user who selects acquisition of a media material in a transaction occurring at least partially over the network, the selected employment advertisement being for an employment position associated with at least one employment skill also associated with the user-selected media material.

2. The method of claim 1, further comprising providing the selected employment advertisement to the user over the network at a time substantially when the user selects acquisition of the media material.

3. The method of claim 1, further comprising providing the selected employment advertisement to the user over the network at a time substantially when the user confirms payment for acquisition of the media material.

4. The method of claim 1, further comprising generating a score for each of a plurality of employment advertisements, wherein the selected employment advertisement has a score above a threshold value.

5. The method of claim 4, further comprising selecting a plurality of employment advertisements to provide over the network to the user, each of the plurality of selected advertisements having a score above the threshold value.

6. The method of claim 1, wherein, if the user selects acquisition of a plurality of media materials in a transaction occurring at least partially over the network, the selected employment advertisement has at least one commonly associated employment skill with each of the plurality of media materials, wherein the at least one commonly associated employment skill can be the same or different for each of the plurality of media materials.

7. The method of claim 1, further comprising associating in an electronic database a skill level with each of the plurality of employment positions and associating in an electronic database a skill level with each of the plurality of media materials a user can acquire through a transaction at least partially transacted over a network, wherein the selected employment advertisement is for an employment position having an associated skill level that matches a skill level associated with the user-selected media material.

8. The method of claim 1, further comprising associating in an electronic database a desirability with each employment skill associated with each of the plurality of employment positions, wherein the selected employment advertisement is for an employment position associated with the employment skill having a highest desirability of a plurality of employment skills that match between the employment position and the user-selected media material.

9. The method of claim 1, further comprising associating in an electronic database a confidence level with an employment skill associated with a media material, the confidence level indicating a probability that a user selecting acquisition of the media material has the employment skill associated with the media material.

10. The method of claim 1, further comprising correlating, before the user selects acquisition of the media material, at least one of the plurality of employment positions with at least one of the plurality of media materials if the at least one of the plurality of employment positions is associated with at least one employment skill also associated with the at least one of the plurality of media materials.

11. The method of claim 1, further comprising identifying a keyword associated with a media material and associating in an electronic database at least one employment skill with the media material based on the keyword.

12. The method of claim 11, wherein the keyword is identified based on at least one of a title of the media material, an abstract of the media material, a table of contents of the media material and an author of the media material.

13. The method of claim 1, wherein at least one employment skill associated with the selected employment advertisement is an exact match with at least one employment skill associated with the user-selected media material.

14. The method of claim 1, wherein at least one employment skill associated with the selected employment advertisement is a related match with at least one employment skill associated with the user-selected media material.

15. The method of claim 1, wherein the selected employment advertisement is associated with a geographic region of the user.

16. The method of claim 1, wherein the selected employment advertisement is associated with a purchase history of the user.

17. The method of claim 1, wherein the media material includes at least one of a book, an article, an audio file, and a video file.

18. A system for providing targeted advertisements, comprising:
a first collection of data including a plurality of job nodes, each job node associated with an employment position;
a second collection of data including a plurality of skill nodes, each skill node associated with an employment skill and associated with at least one of the job nodes; and
a third collection of data including a plurality of media nodes, each media node associated with a media material that a user can acquire through a transaction conducted at least partially over a network, and each media node associated with an employment skill associated with at least one of the skill nodes;
a matching engine processor configured to select at least one of the job nodes based at least on a selection by a user over a network of a media material to be delivered to the user, wherein the media material selected by the user is associated with one of the media nodes; and
an employment advertisement processor configured to cause an employment advertisement to be delivered to the user over the network for an employment position associated with the job node selected by the matching engine processor.

19. The system of claim 18, wherein at least one of the first collection of data, the second collection of data, and the third collection of data is configured as a directed acyclic graph (DAG).

20. The system of claim 19, wherein the second collection of data is configured as a DAG, and wherein a selected skill node in the plurality of skill nodes is further associated with an employment skill associated with a skill node in the plurality of skills nodes located downstream in the second collection of data from the selected skill node.

21. The system of claim 18, wherein the matching engine processor is configured to select one of the job nodes considering a desirability of an employment skill associated with the media node for the user-selected media material.

22. The system of claim 18, wherein, if the user selects a plurality of media materials to be delivered to the user, the matching engine processor is configured to select a job node considering each of the user-selected media materials, wherein each of the media materials selected by the user is associated with one of the media nodes.

23. The system of claim 18, wherein the employment advertisement is associated with a geographic region of the user.

24. The system of claim 18, wherein the media material includes at least one of a book, an article, an audio file, and a video file.

25. A system for serving employment advertisements to a user who is browsing for professional content through a content provider's server, the system comprising:
an ontology processor, the ontology processor having a memory for storing employment, skill, and content information in a graph having:
nodes associated with content,
nodes associated with skills, and
nodes associated with employment positions,
the nodes being connected by edges that represent associations between the content, skills, and employment positions;
a matching engine processor in communication with a content provider's server to monitor the behavior of users interacting with content through the content provider's server, the matching engine processor further communicating with the ontology processor to generate a score that a user is qualified for an employment position based upon the user's behavior with respect to the content and the associations between the content, skills, and employment positions stored by the ontology processor; and
an employment advertisement processor that causes an employment advertisement to be displayed to the user for an employment position for which the matching engine processor has calculated a qualifying score.
